(19) United States
(12) Patent Application Publication
(10) Pub. No.: US 2025/0384063 A1
(43) Pub. Date: Dec. 18, 2025

(54) SECURING RETRIEVAL AUGMENTED GENERATION

(71) Applicant: International Business Machines Corporation, Armonk, NY (US)

(72) Inventors: Kieran Fraser, Raheny (IE); Erik Miehling, Malahide (IE); Ambrish Rawat, Dublin (IE); Elizabeth Daly, Dublin (IE); Juan Bernabe-Moreno, Dublin (IE)

(21) Appl. No.: 18/746,775

(22) Filed: Jun. 18, 2024

(51) Int. Cl. G06F 16/332; G06F 16/33; G06F 40/30

(52) U.S. Cl. CPC G06F 16/3325; G06F 16/3344; G06F 40/30

(57) ABSTRACT

An exemplary system comprises a memory that stores and a processor that executes computer executable components stored in the memory, wherein the computer executable components comprise an obtaining component that intercepts a semantic source from being submitted to a retrieval augmented generation (RAG) architecture, and a transforming component that transforms the semantic source into a transformed source by identifying and converting prompt-misleading text of the semantic source into prompt-non-misleading text. In one or more embodiments, the semantic source is a semantic query having been submitted to the RAG architecture and/or a retrieved source having been retrieved by the RAG architecture in a process of providing a prompt. In one or more embodiments, the prompt-misleading text originated in connection with an origination of the semantic source and/or was caused by an adversarial attack corresponding to the semantic source.

### BACKGROUND

The subject disclosure relates to retrieval augmented generation, and more particularly to securing of various inputs to retrieval augmented generation architectures.

### SUMMARY

The following presents a summary to provide a basic understanding of one or more embodiments described herein. This summary is not intended to identify key or critical elements, and/or to delineate scope of particular embodiments or scope of claims. Its sole purpose is to present concepts in a simplified form as a prelude to the more detailed description that is presented later. In one or more embodiments, systems, computer-implemented methods, apparatuses and/or computer program products described herein can provide a process to secure input to retrieval augmented generation (RAG) architectures.

In accordance with an embodiment, a system can comprise a memory that stores and a processor that executes computer executable components stored in the memory, wherein the computer executable components comprise an obtaining component that intercepts a semantic source from being submitted to a retrieval augmented generation (RAG) architecture, and a transforming component that transforms the semantic source into a transformed source by identifying and converting prompt-misleading text of the semantic source into prompt-non-misleading text.

In accordance with another embodiment, a method can comprise intercepting, by a system operatively coupled to a processor, a semantic source from being submitted to a retrieval augmented generation (RAG) architecture, and transforming, by the system, the semantic source into a transformed source by identifying and converting prompt-misleading text of the semantic source into prompt-non-misleading text.

In accordance with another embodiment, a computer program product, for facilitating a process to secure input to retrieval augmented generation (RAG) architectures, can comprise a computer readable storage medium having program instructions embodied therewith, the program instructions executable by a processor to cause the processor to: intercept, by the processor, a semantic source from being submitted to a retrieval augmented generation (RAG) architecture, and transform, by the processor, the semantic source into a transformed source by identifying and converting prompt-misleading text of the semantic source into prompt-non-misleading text.

A benefit of the system, computer-implemented method and/or computer program product, can be an ability to automatically mitigate effect of adversarial attacks to inputs of a RAG architecture, thereby resulting in non-biased and/or factual prompts.

Another benefit can be an ability to provide the aforementioned mitigation with one or more processes being agnostic to RAG architecture type and/or to language model (LM) type.

### DESCRIPTION OF THE DRAWINGS

FIG. 1 illustrates a block diagram of an example, non-limiting system that can provide a process to secure input to retrieval augmented generation (RAG) architectures, in accordance with one or more embodiments described herein.

FIG. 2 illustrates a block diagram of another example, non-limiting system that can provide a process to secure input to retrieval augmented generation (RAG) architectures, in accordance with one or more embodiments described herein.

FIG. 3 illustrates a flow diagram of one or more high-level processes that can be performed by the non-limiting system of FIG. 2, in accordance with one or more embodiments described herein.

FIG. 4 illustrates a flow diagram of one or more detailed processes that can be performed by the non-limiting system of FIG. 2, in accordance with one or more embodiments described herein.

FIG. 5 illustrates a flow diagram of one or more evaluating processes that can be performed by the non-limiting system of FIG. 2, in accordance with one or more embodiments described herein.

FIG. 6 illustrates a flow diagram of one or more training processes that can be performed by the non-limiting system of FIG. 2, in accordance with one or more embodiments described herein.

FIG. 7 illustrates a block diagram of a set of processes that can be performed by the non-limiting system of FIG. 2, to secure input to retrieval augmented generation (RAG) architectures, in accordance with one or more embodiments described herein.

FIG. 8 illustrates a block diagram of another set of processes that can be performed by the non-limiting system of FIG. 2, to secure input to retrieval augmented generation (RAG) architectures, in accordance with one or more embodiments described herein.

FIG. 9 illustrates a block diagram of a continuation of the set of processes of FIG. 8 that can be performed by the non-limiting system of FIG. 2, in accordance with one or more embodiments described herein.

FIG. 10 illustrates a block diagram of an example, non-limiting, computer environment in accordance with one or more embodiments described herein.

### DETAILED DESCRIPTION

The following detailed description is merely illustrative and is not intended to limit embodiments and/or application or utilization of embodiments. Furthermore, there is no intention to be bound by any expressed or implied information presented in the preceding Summary section, or in the Detailed Description section. One or more embodiments are now described with reference to the drawings, wherein like reference numerals are utilized to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In practice, a retrieval augmented generation (RAG) architecture (e.g., RAG architecture) is an artificial intelligence (AI) framework for retrieving facts from an external knowledge base to ground large language models (LLMs) on the most accurate, up-to-date information and to give users insight into LLMs' generative processes.

Generally, RAG has two phases, which are context retrieval and content generation. In the retrieval phase, algorithms search for and retrieve snippets of information relevant to the user's prompt or question. In an open-domain, consumer setting, that information can come from indexed documents on the internet or other public repository. In a closed-domain, enterprise setting, a narrower set of sources are often used for added security and/or reliability. In the generative phase, the LLM draws from the augmented prompt and from an internal representation of the LLM's training data to synthesize an engaging answer tailored to the user entity in that instant. The answer can then be passed to a chatbot with links to its sources.

As RAG architectures become more common and/or usage of RAG architectures increases, bad acting entities (e.g., bad entities) continue to develop new methods to disrupt and/or redirect RAG architecture processes, resulting in process failure, incorrect output and/or undesirably augmented output (e.g., putting unequal bias on one or more outputs, omitting one or more outputs, adding one or more improper outputs, and/or providing incomprehensible output). These adversarial attacks can be intentional (e.g., caused by a bad acting entity) and/or unintentional (e.g., corresponding to inaccurate input). These adversarial attacks can be directed towards various inputs to a RAG architecture, such as the query input and/or a retrieved source input.

In practice, detection of potentially harmful and/or malicious inputs can be a difficult, dynamic, and/or resource-consuming process resulting in less than desirable mitigation of impact of such inputs, which in turn can result in non-factual and/or biased RAG outputs. That is, problems with existing frameworks can comprise, but certainly are not limited to, vulnerability of RAG systems to malicious or misleading prompts which can cause the model to produce biased, incorrect, and/or harmful outputs, inadequate safeguards against injection attacks which can manipulate the context and/or thereby influence model answers, and/or difficulty in quantifying uncertainty in generated responses. Such uncertainty can arise, for example, due to a model not having a correct answer and/or attempting to resolve multiple correct answers.

To account for one or more deficiencies of existing RAG frameworks and/or RAG management frameworks, the one or more embodiments described herein generally can provide for sanitizing of one or more inputs to a RAG architecture. That is, the one or more embodiments described herein can automatically intercept bad inputs (e.g., prompt-misleading text comprising harmful, non-factual, malicious, redirecting, biased, etc. text) of a RAG architecture, transform bad inputs into good inputs, and/or subsequently replace the bad inputs with prompt-non-misleading text for use by the RAG architecture. Accordingly, the one or more embodiments described herein can function in parallel with a RAG architecture, allowing the one or more embodiments to be agnostic to RAG type and/or structure, and/or agnostic to LLM type and/or structure (e.g., an LLM employed by a RAG).

Generally, one or more embodiments described herein can provide improvements over existing frameworks, the improvements including, but not limited to, attack detection, attack mitigation, output factuality, reduced bias, uncertainty quantification and/or application flexibility. Regarding attack detection and/or mitigation, the one or more embodiments described herein can recognize potentially harmful and/or misleading inputs and sanitize them. Additionally, by pre-processing prompts and utilizing semantically similar prompts, a system described herein can minimize a corresponding LLM's exposure to misleading information. Regarding output factuality and/or reduced bias, by ensuring the prompts fed to the RAG system are safe and representative of the original intent, the one or more embodiments described herein can improve a likelihood of factual and/or unbiased outputs. Regarding uncertainty quantification, the one or more embodiments described herein can employ variability of generated responses to generate decision reports and/or to drive queries to the user entity for clarification (e.g., to resolve ambiguity arising from multiple correct answers). Regarding application flexibility, the model-agnostic design of the one or more embodiments described herein can allow for integration with various RAG architectures, ensuring widespread applicability.

As used herein, the term “adversarial” is intended to mean with adversary and/or without adversary. That is, an adversarial attack need not be purposely malicious, but rather could be accidental and/or have a malicious result based on a non-malicious intent. As such, the term “adversarial attack” is meant to encompass any action that changes an initial write action, storage action, etc. and/or that supplements an initial write action, storage action, etc., in a manner that results in prompt-misleading text.

As used herein, the term “data” can comprise metadata.

As used herein, the terms “entity,” “requesting entity,” and “user entity” can refer to a machine, device, component, hardware, software, smart device, party, organization, individual and/or human.

As used herein, the term “prompt” refers to a semantic grouping of text output from a prompt generator of a RAG architecture or otherwise employed for use by a language model of and/or associated with a RAG architecture.

As used herein, the term “prompt-misleading text” can comprise, but is not limited to added words, pronoun swapping, synonym swapping, deleted words, repeated words, particular words, grammatical aspect reordering, inherent, explicit, passive and/or active bias, etc.

As used herein, the term “prompt-non-misleading text” refers to text that is based on “prompt-misleading text,” but instead at least partially addresses bias, misleading text, wrong prompt, etc. caused by the “prompt-misleading text.”

One or more embodiments are now described with reference to the drawings, where like referenced numerals are used to refer to like elements throughout. In the following description, for purposes of explanation, numerous specific details are set forth to provide a more thorough understanding of the one or more embodiments. It is evident in various cases, however, that the one or more embodiments can be practiced without these specific details.

Further, it should be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein.

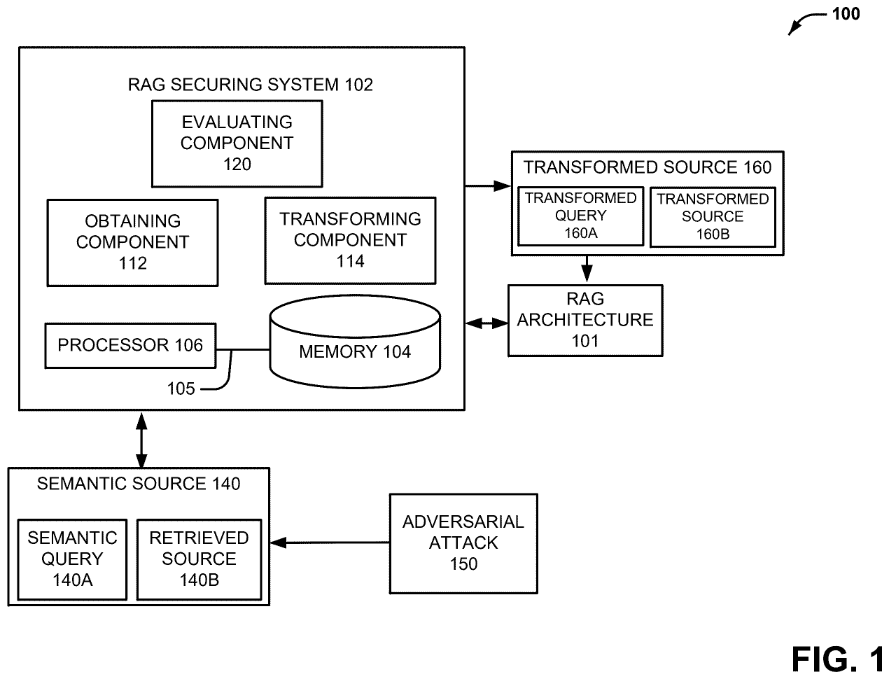

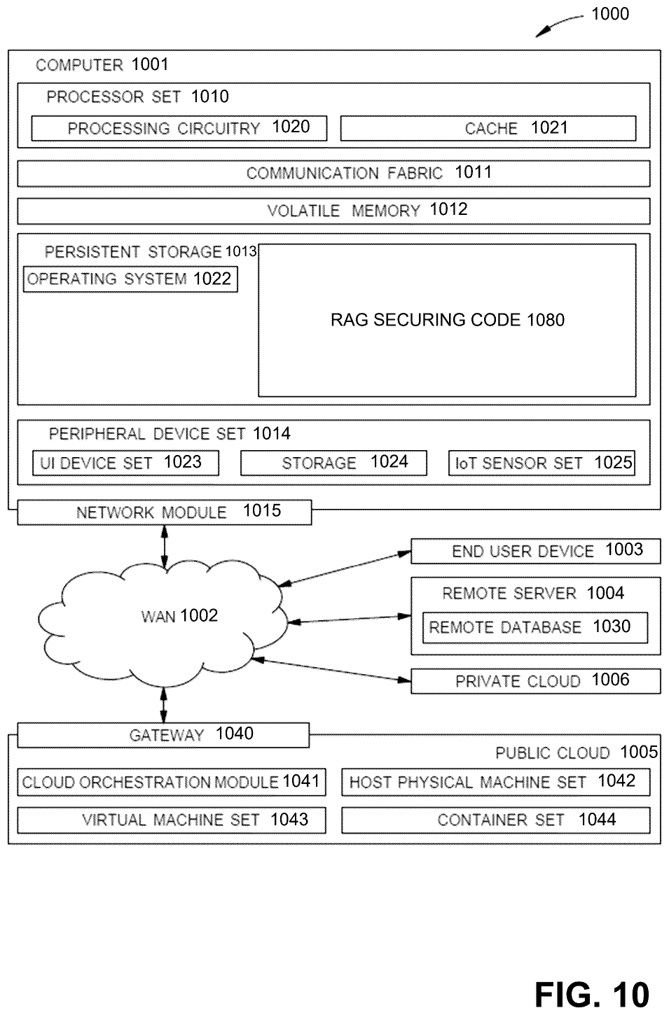

For example, in one or more embodiments, the non-limiting system 100 (FIG. 1) can further comprise one or more computer and/or computing-based elements described herein with reference to a computing environment, such as the computing environment 1000 illustrated at FIG. 10. In one or more described embodiments, computer and/or computing-based elements can be used in connection with implementing one or more of the systems, devices, components and/or computer-implemented operations shown and/or described in connection with FIG. 1 and/or with one or more other figures described herein.

Turning now in particular to one or more figures, and first to FIG. 1, illustrated is a block diagram of an example, non-limiting system 100 that can facilitate a process to secure an input to a retrieval augmented generation (RAG) architecture, such as RAG architecture 101. The non-limiting system 100 can comprise a RAG securing system 102. In one or more embodiments, the non-limiting system can comprise and/or be communicatively coupled to a RAG architecture 101 (also herein referred to as a RAG architecture 101).

In general, the non-limiting system 100 can employ any suitable method of communication (e.g., electronic, communicative, internet, infrared, fiber, etc.) to provide communication between the classical system 102 and the quantum system 301.

The RAG securing system 102 can comprise a processor 106, bus 105, memory 104, obtaining component 112 and/or transforming component 114.

The obtaining component 112 generally can intercept a semantic source 140 from being submitted to a retrieval augmented generation (RAG) architecture 101. In one or more embodiments, the semantic source 140 can be a semantic query 140A or a retrieved source 140B. In one or more embodiments, an adversarial attack 150 can have manipulated the semantic source 140 and/or the semantic source can have prompt-misleading text originating elsewhere and/or by another cause.

The transforming component 114 generally can direct the query to an ensemble of LLMs promoting self-consistency across responses. That is, the transforming component 114 generally can transform the semantic source 140 into a transformed source 160 (e.g., a transformed query 160A corresponding to the semantic query 140A, or a transformed source 160B corresponding to the retrieved source 140B) by identifying and converting prompt-misleading text of the semantic source 140 into prompt-non-misleading text for the transformed source 160. Prompt-misleading text can comprise, but is not limited to, added words, pronoun swapping, synonym swapping, deleted words, repeated words, particular words, biasing words, grammatical aspect reordering, and/or inherent, explicit, passive and/or active bias.

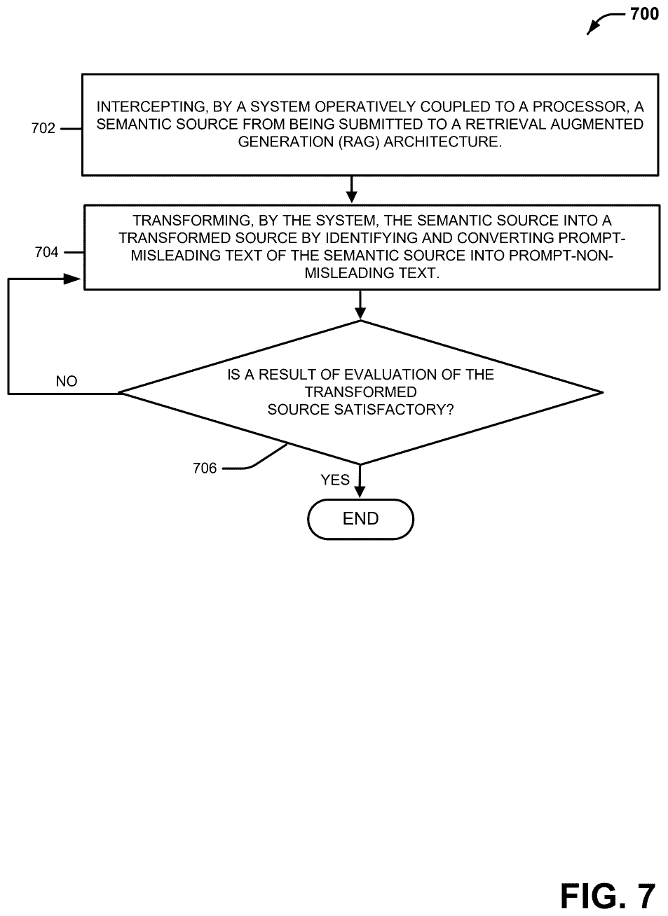

As a brief summary, referring next briefly to FIG. 7, illustrated is a flow diagram of an example, non-limiting method 700 that can provide a process to secure an input to a retrieval augmented generation (RAG) architecture, in accordance with one or more embodiments described herein, such as the non-limiting system 100 of FIG. 1. Repetitive description of like elements and/or processes employed in respective embodiments is omitted for sake of brevity.

At 702, the non-limiting method 700 can comprise intercepting, by a system operatively coupled to a processor (e.g., obtaining component 112), a semantic source (e.g., semantic source 140) from being submitted to a retrieval augmented generation (RAG) architecture (e.g., RAG architecture 101).

At 704, the non-limiting method 700 can comprise transforming, by the system (e.g., transforming component 114), the semantic source into a transformed source (e.g., transformed source 160) by identifying and converting prompt-misleading text of the semantic source into prompt-non-misleading text for the transformed source.

At 706, the non-limiting method 700 can comprise determining, by the system (e.g., evaluating component 120), whether a result of an evaluation of the transformed source is satisfactory. If not, the non-limiting method 700 can return back step 702 for additional transforming based on an output of the evaluating component 220. If yes, the non-limiting method 700 can proceed to end.

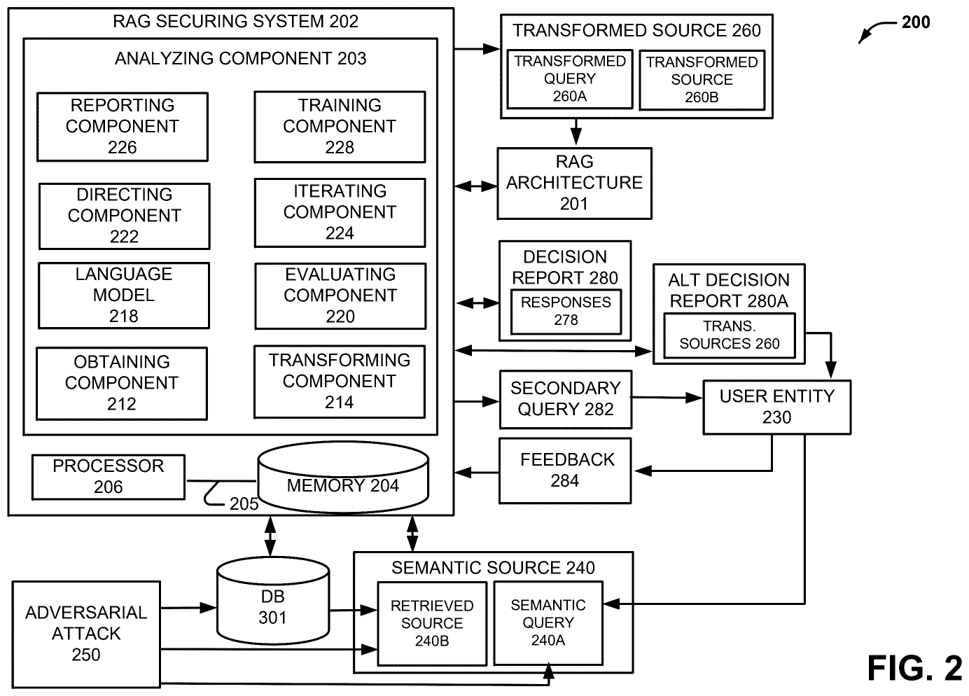

Turning next to FIG. 2, a non-limiting system 200 is illustrated that can comprise a RAG securing system 202. Repetitive description of like elements and/or processes employed in respective embodiments is omitted for sake of brevity. Description relative to an embodiment of FIG. 1 can be applicable to an embodiment of FIG. 2. Likewise, description relative to an embodiment of FIG. 2 can be applicable to an embodiment of FIG. 1.

Generally, the non-limiting system 200 can facilitate a process to secure an input to a retrieval augmented generation (RAG) architecture 201 (e.g., RAG 201) and can perform one or more processes in parallel with one or more processes of the RAG architecture 201. That is, the RAG securing system 202 generally can provide a safe prompting approach using semantic similarity through paraphrasing to provide RAG agnostic pug-and-play interaction with a RAG architecture 201.

One or more communications between one or more components of the non-limiting system 200 can be provided by wired and/or wireless means including, but not limited to, employing a cellular network, a wide area network (WAN) (e.g., the Internet), and/or a local area network (LAN). Suitable wired or wireless technologies for supporting the communications can include, without being limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (Ipv6 over Low power Wireless Area Networks), Z-Wave, an advanced and/or adaptive network technology (ANT), an ultra-wideband (UWB) standard protocol and/or other proprietary and/or non-proprietary communication protocols.

Turning first to the adversarial attacks 250, such attacks, as noted above, can be intended with adversary and/or without adversary. That is, an adversarial attack 250 need not be purposely malicious, but rather could be accidental and/or have a malicious result based on a non-malicious intent. As such, an adversarial attack 250 can comprise an action that changes an initial write action, storage action, etc. and/or that supplements an initial write action, storage action, etc., in a manner that results in prompt-misleading text. For example, an adversarial attack 250 can comprise content creation and/or content manipulation, thereby resulting in generation of prompt-misleading text, as defined herein.

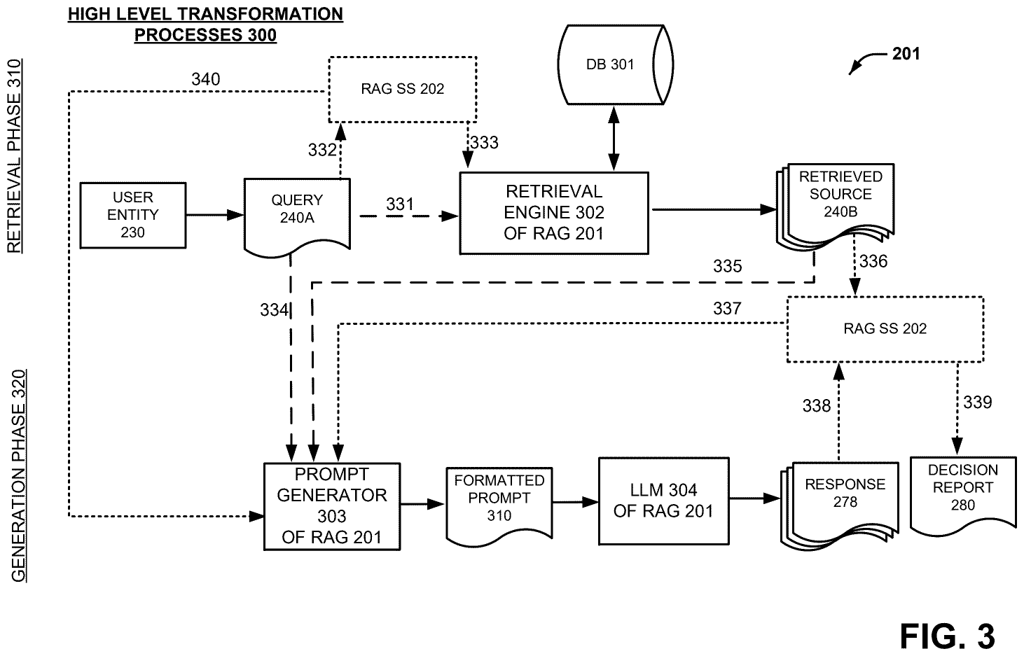

In one example, an adversarial attack 250 can correspond to a semantic query 240A. In another example, an adversarial attack 250 can correspond to retrieved source 240B and/or source of context, such as database (DB) 301 (FIG. 3). That is, an adversarial attack 250 can be on the user entity 230, on a device associated with the user entity 230, on a semantic query 240A directly, on a source of context employed by a retrieval engine 302 (e.g., on a database and/or internet source, site and/or code), on a retrieved source 240B directly, and/or on the RAG architecture 201 directly.

In one example, an adversarial attack 250 can employ a query that is known to be adversarial to an LLM 304 (FIG. 3) used by a RAG architecture 201 and/or that is tuned (e.g., the query is tuned) to retrieve a particular context (e.g., retrieved source) during retrieval augmented generation which, when combined with the query, results in a bad prompt (e.g., formatted prompt 310 of FIG. 3) that is adversarial to the LLM 304 used by the RAG architecture 201.

Turning next to the RAG architecture 201 and its functioning, apart from separate functioning of the RAG securing system 202, a RAG architecture 201 can comprise any one or more of software, hardware and/or firmware, and can omit any one or more of software, hardware and/or firmware.

Turning briefly to FIG. 3, as noted above, the RAG architecture 201 generally has two phases, which are context retrieval (e.g., retrieval phase 310) and content generation (e.g., generation phase 320). These phases are conducted by the retrieval engine 302, prompt generator 303 and LLM 304 of the RAG architecture 201. The retrieval engine 302 and prompt generator 303 can comprise and/or function in association with a corresponding RAG processor, memory and/or bus. The LLM 304 can be any suitable large language model that can on in association with a corresponding RAG processor, memory and/or bus. One or more LLMs 304 can be comprised and/or employed by a RAG architecture 201. The one or more LLMs 304 can comprise any suitable artificial intelligence (AI), machine learning (ML) architecture, neural network (NN) architecture and/or robust paraphrasing model.

During the retrieval phase 310, a retrieval engine 302 can obtain the semantic query 240A, such as via path 331, thereby triggering initiation of the RAG architecture 201. RAG algorithms comprised by and/or otherwise associated with the retrieval engine 302 of the RAG architecture 201 can search for and retrieve data/metadata of information (e.g., retrieved source 240B) relevant to a semantic query 240A obtained/received from a user entity 230. In one or more embodiments, to facilitate this search, a semantic query 240A can be converted into a vector using an embedding model by the retrieval engine, and top-k similar vectors can be retrieved by the retrieval engine 302. In an open-domain, consumer setting, such information can come from indexed documents on the internet (e.g., database or DB 301). In a closed-domain, enterprise setting, a narrower set of sources (also represented at FIG. 3 as DB 301) are typically employed for added security and reliability. Accordingly, the DB 301 can represent an open, local, public and/or private database, site, server or other storage where one or more contexts can be obtained in the form of one or more retrieved sources 240B. It is noted that a retrieved source 240B need not be a full source, but rather, in one or more cases, can be a portion of text, portion of code, snippet, data, metadata, etc.

In the generation phase 320, a prompt generator 303 of the RAG architecture 201 can generate an augmented prompt based on the query semantic and on the retrieved source 240B. The semantic query 240A can be obtained by the prompt generator 303 by path 334. The retrieved source 240B (or more than one retrieved sources 240B) can be obtained by the prompt generator 303 via path 335. An LLM 304 of the RAG architecture 201 can draw from the augmented prompt and from an internal representation of training data corresponding to the LLM 304, to synthesize an engaging response 278, such as tailored to the user entity 230 in that instant execution iteration. The response 278 can then be passed to a user entity 230, such as via a chatbot or other system, such as accompanied by one or more with links defining one or more sources employed by the RAG architecture 201.

As also illustrated at FIG. 3, the RAG securing system 202 can function at least partially in parallel with, and/or in series with, the RAG architecture 201 to provide more efficient and/or non-prompt-misleading text to the retrieval engine 302 and/or prompt generator 303 of the RAG architecture 201. For example, staying at a high level of description, the RAG securing system (RAG SS) 202 can interact with the RAG architecture 201 during each of the retrieval phase 310 and the generation phase 320. During the retrieval phase 310, the RAG securing system 202 can replace and/or supplement the path 331 with the paths 332 and 333. During the generation phase 320 (or between the retrieval phase 310 and the generation phase 320), the RAG securing system 202 can replace and/or supplement the path 334 with the path 340. Also during the generation phase 320 (or between the retrieval phase 310 and the generation phase 320), the RAG securing system 202 can replace and/or supplement the path 334 with the path 340, the RAG securing system 202 can replace the path 335 with the paths 336 and 337. Also during the generation phase 320, The RAG securing system 202 can generally supplement the RAG architecture 201 with generation of a decision report 280 based on one or more responses 278, using the paths 338 and 339 as illustrated.

Turning next to the RAG securing system 202, generally, the RAG securing system 202 can facilitate/execute one or more processes including, but not limited to, transformation of a user entity query into a robust query comprising prompt-non-misleading text. The one or more embodiments can direct use of the robust query at the prompt generator 303 (FIG. 3) and retrieval engine 302 (FIG. 3) of the RAG architecture 201. The retrieval engine 302 can pull relevant documents from a context database (DB) 301 (FIG. 3). The one or more embodiments described herein can intercept the documents, and can transform the documents into robust documents comprising prompt-non-misleading text. The one or more embodiments can direct use of the robust documents at the prompt generator 303 of the RAG architecture 201. The prompt generator's output can be employed by an LLM 304 (FIG. 3) of the RAG architecture 201 to generate a final response 278. In a case of one or more final outputs being generated, the one or more embodiments described herein can aggregate the one or more final outputs (e.g., one or more final responses 278) and provide a decision report 280 and/or one or more user entity queries (e.g., secondary queries 282).

The RAG securing system 202 can be associated with, such as accessible via, a cloud computing environment.

The RAG securing system 202 can comprise a plurality of components. The components can comprise a memory 204, processor 206, bus 205, obtaining component 212, transforming component 214, language model 218, evaluating component 220, directing component 222, iterating component 224, reporting component 226, and/or training component 228. Using these components, and optionally employing the RAG architecture 201, the non-limiting system 200 generally can facilitate a process to secure input to a retrieval augmented generation (RAG) architecture, such as RAG architecture 201.

Discussion first turns briefly to the processor 206, memory 204 and bus 205 of the RAG securing system 202. For example, in one or more embodiments, the RAG securing system 202 can comprise the processor 206 (e.g., computer processing unit, microprocessor, classical processor, quantum processor and/or like processor). In one or more embodiments, a component associated with RAG securing system 202, as described herein with or without reference to the one or more figures of the one or more embodiments, can comprise one or more computer and/or machine readable, writable and/or executable components and/or instructions that can be executed by processor 206 to provide performance of one or more processes defined by such component and/or instruction. In one or more embodiments, the processor 206 can comprise the obtaining component 212, transforming component 214, language model 218, evaluating component 220, directing component 222, iterating component 224, reporting component 226, and/or training component 228.

In one or more embodiments, the RAG securing system 202 can comprise the computer-readable memory 204 that can be operably connected to the processor 206. The memory 204 can store computer-executable instructions that, upon execution by the processor 206, can cause the processor 206 and/or one or more other components of the RAG securing system 202 (e.g., obtaining component 212, transforming component 214, language model 218, evaluating component 220, directing component 222, iterating component 224, reporting component 226, and/or training component 228) to perform one or more actions. In one or more embodiments, the memory 204 can store computer-executable components (e.g., obtaining component 212, transforming component 214, language model 218, evaluating component 220, directing component 222, iterating component 224, reporting component 226, and/or training component 228).

The RAG securing system 202 and/or a component thereof as described herein, can be communicatively, electrically, operatively, optically and/or otherwise coupled to one another via a bus 205. Bus 205 can comprise one or more of a memory bus, memory controller, peripheral bus, external bus, local bus, quantum bus and/or another type of bus that can employ one or more bus architectures. One or more of these examples of bus 205 can be employed.

In one or more embodiments, the RAG securing system 202 can be coupled (e.g., communicatively, electrically, operatively, optically and/or like function) to one or more external systems (e.g., a non-illustrated electrical output production system, one or more output targets and/or an output target controller), sources and/or devices (e.g., classical and/or quantum computing devices, communication devices and/or like devices), such as via a network. In one or more embodiments, one or more of the components of the RAG securing system 202, RAG architecture 201, and/or more generally of the non-limiting system 200, can reside in the cloud, and/or can reside locally in a local computing environment (e.g., at a specified location).

In general, the non-limiting system 200 can employ any suitable method of communication (e.g., electronic, communicative, internet, infrared, fiber, etc.) to provide communication between the RAG securing system 202 and the RAG architecture 201.

In addition to the processor 206 and/or memory 204 described above, the RAG securing system 202 can comprise one or more computer and/or machine readable, writable and/or executable components and/or instructions that, when executed by processor 206, can provide performance of one or more operations defined by such component and/or instruction.

Discussion next refers still to FIGS. 2 and 3 and to the additional components of the RAG securing system 202 (e.g., obtaining component 212, transforming component 214, language model 218, evaluating component 220, directing component 222, iterating component 224, reporting component 226, and/or training component 228).

First, it is noted that in one or more embodiments, the obtaining component 212, transforming component 214, language model 218, evaluating component 220, directing component 222, iterating component 224, reporting component 226, and/or training component 228 can be implemented independently, without one or more other of the obtaining component 212, transforming component 214, language model 218, evaluating component 220, directing component 222, iterating component 224, reporting component 226, and/or training component 228. Additionally and/or alternatively, the obtaining component 212, transforming component 214, language model 218, evaluating component 220, directing component 222, iterating component 224, reporting component 226, and/or training component 228 can be comprised by a high-level analyzing component 203, one or more of the below-described functions of the obtaining component 212, transforming component 214, language model 218, evaluating component 220, directing component 222, iterating component 224, reporting component 226, and/or training component 228 can be performed by the high-level analyzing component 203, and/or the obtaining component 212, transforming component 214, language model 218, evaluating component 220, directing component 222, iterating component 224, reporting component 226, and/or training component 228 can be omitted with the high-level analyzing component 203 performing one or more of the below-described functions of the one or more omitted obtaining component 212, transforming component 214, language model 218, evaluating component 220, directing component 222, iterating component 224, reporting component 226, and/or training component 228.

Turning now specifically to the obtaining component 212, and still referring to FIGS. 2 and 3, the obtaining component 212 generally can find, locate, determine, request, download, read and/or otherwise obtain information (e.g., data and/or metadata of a semantic source 240) corresponding to an input to the RAG architecture 201. That is, regarding the aforementioned safe prompting approach, a benign user query, either original or augmented post-RAG, can be input to a RAG architecture 201 and intercepted by the obtaining component 212.

In one or more embodiments, this can be facilitated by tracking requests, inputs and/or communications to the RAG architecture 201. For example, the obtaining component 212 can search for data tags related to the RAG architecture 201 and/or search specified means of incoming communication employed by the RAG architecture 201.

In one or more embodiments, points in a RAG architecture 201 at which a semantic source 240 can be intercepted can comprise before being transformed to embedding, before being passed to a representational state transfer application programming interface (REST API) and/or before being retrieved based on a call function from a library and/or software development kit (SDK).

In one or more embodiments, the semantic source 240 can be a semantic query 240A having been submitted to the RAG architecture 201 and/or a retrieved source 240B having been retrieved by the RAG architecture in a process of providing a prompt. In one or more embodiments, the prompt-misleading text can have originated in connection with an origination of the semantic source, such as by an initial bad actor actively providing bad, biased and/or otherwise malicious information, and/or such by accident or unintended action. In one or more embodiments, the prompt-misleading text can have been caused by an adversarial attack 250 corresponding to the semantic source, whether being an adversarial attack 250 on the user entity 230, on a device associated with the user entity 230, on a semantic query 240A directly, on a source of context employed by a retrieval engine 302 (e.g., on a database and/or internet source, site and/or code), on a retrieved source 240B directly, and/or on the RAG architecture 201 directly.

It is noted that in one or more embodiments, the obtaining component 212 can instead copy and/or obtain a copy of the semantic source 240 instead of preventing the retrieval engine 302 and/or prompt generator 303 of the RAG architecture 201 from obtaining the semantic source 240. In such case, the RAG securing system 202 (RAG SS 202) still can provide a transformed source 260 to the retrieval engine 302 and/or prompt generator 303 of the RAG architecture 201, while also optionally directing/requesting use, by the RAG architecture 201, of the transformed source 260 instead of the original semantic source 240.

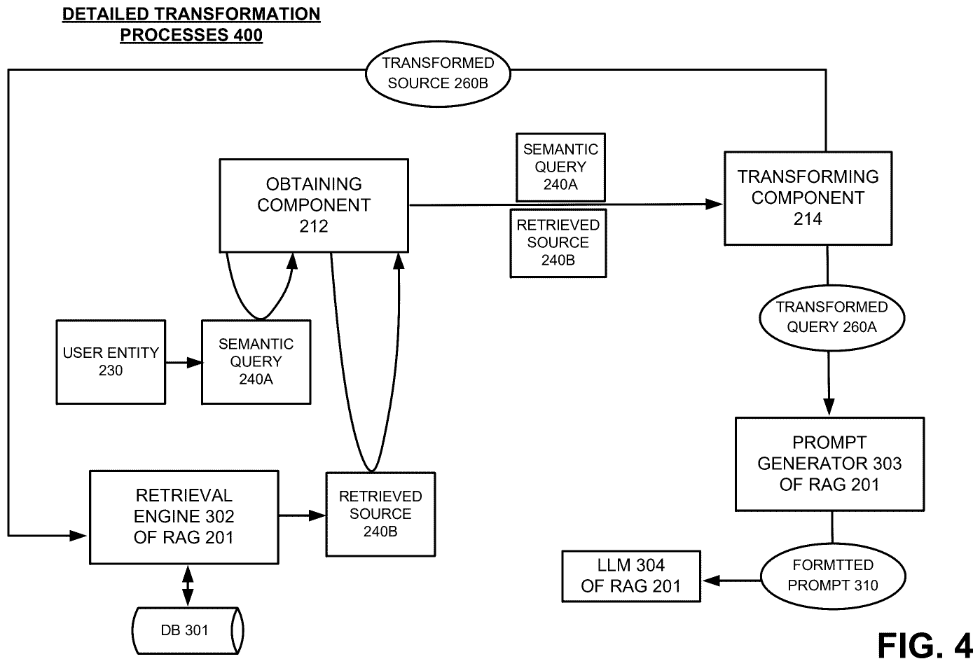

Accordingly, looking at FIG. 4, and still to FIGS. 2 and 3, provided is an illustration of detailed transformation processes 400 in greater granularity than as illustrated at FIG. 3. The obtaining component 212 can obtain, retrieve and/or intercept a semantic query 240A from a user entity 230, which semantic query 240A is/was otherwise intended for the RAG architecture 201, such as the retrieval engine 303 and/or prompt generator 304. The obtaining component 212 likewise can obtain, retrieve and/or intercept a retrieved source 240B, which has been output by a retrieval engine 302 of a RAG architecture 201, which retrieved source 240B was otherwise intended for another component of the RAG architecture 201, such as the prompt generator 303.

Turning next to the transforming component 214, the component generally can direct the semantic source 240 to an ensemble of language models (LMs) such as LLMs (e.g., language model 218), thereby promoting self-consistency across plural responses 278 for same and/or similar queries. In one or more cases, a large language model (LLM) can be distinguished by use of an extended quantity of parameters thereby provided for extended capacity to process and generate text compared to small language models. Accordingly, an LLM can process increasingly complex languages, grammar and/or language-based tasks, including reducing and/or transforming prompt-misleading text.

As used herein, prompt-misleading text can comprise, but is not limited to added words, pronoun swapping, synonym swapping, deleted words, repeated words, particular words, grammatical aspect reordering, biased terminology, etc. For example, repeated words can cause a different prompt 310 to be formed than text without the repeated words. Misspelled words, deleted words, grammatical reordering of sentence structure and/or the like also can cause a different prompt 310 to be formed than text without such prompt-misleading text examples. Accordingly, by removing the prompt-misleading text (e.g., by transforming the prompt-misleading text into prompt-non-misleading text and/or by generating prompt-non-misleading text based on the prompt-misleading text), more efficient, accurate, and/or truthful prompts 310 can be generated by a prompt generator 303 of a RAG architecture 201, which can directly allow for more efficient, accurate and/or truthful responses 278 to be subsequently generated by an LLM 304 of a RAG architecture 201.

That is, the transforming component 214 generally can transform the semantic source 240 into a transformed source 260 by identifying and converting prompt-misleading text of the semantic source 240 into prompt-non-misleading text of a transformed source 260. For example, the transforming component 214 can transform a semantic query 240A into a transformed query 260A. Where the semantic query 240A was intercepted, the corresponding transformed query 260A can therefore be transformed prior to initiation of an execution of the RAG architecture 201. In another example, a retrieved source 240B can be transformed into a transformed retrieved source 260B. In one or more embodiments, a plurality of retrieved sources 240B, retrieved in series and/or parallel by a retrieval engine 302, can be transformed in series or in parallel (e.g., at least partially in a parallel with one another) by the transforming component 214.

In one or more embodiments, the transforming component 214, and/or the RAG securing system 202, can function proactively by searching a context database employed by a RAG architecture 201 for context documents to transform. That is, in such one or more cases, a retrieved source 240B can instead be not-yet-retrieved and rather merely be a source 240B or not-yet-retrieved source 240B. The discussion herein regarding transformation of a retrieved source 240B applies equally to such not-yet-retrieved sources 240B.

In one or more embodiments, the transforming component 214 and/or a language model 218 can employ bidirectional and auto-regressive transformer paraphrasing (BART-paraphrasing). BART-paraphrasing refers to a process using a denoising autoencoder. For example, the transforming component 214 can filter the semantic source 240, find semantically similar sources based on the filtering, return an average set of context items (e.g., using one or more databases as described herein), paraphrase the context items returned (e.g., using bart-paraphrasing), find semantically similar context items based on the paraphrasing, and return one or more most frequent answers. A database employed can comprise data/metadata in any suitable format (e.g., list, matrix, code, vector) and can comprise historical data (e.g., past responses, transformed sources and/or semantic sources) and/or any other specified context (e.g., private, public, local, etc.).

In one or more embodiments, one or more hyperparameters associated with the transforming can be specified, such as by a user entity. These hyperparameters can include, but are not limited to, maximum number of context documents employed, thresholding for choosing relevant context documents as per similarity, and/or number of language models 218 to employ.

That is, the transforming component 214 can perform one or more of these transformation functions in association with (e.g., can employ) one or more language models 218. In one or more embodiments, a language model 218 can be comprised by the RAG securing system 202 and/or by the non-limiting system 200 more generally. In one or more other embodiments, a language model 218 can be external to the RAG securing system 202 and/or to the non-limiting system 200 more generally.

Regarding the language model 218, in one or more embodiments, the LM 218 can be an LLM. In one or more embodiments, one or more LMs 218 and/or one or more LLMs 304 can comprise any suitable artificial intelligence (AI), machine learning (ML) architecture, neural network (NN) architecture and/or robust paraphrasing model. In one or more embodiments, an LLM 304 employed by the RAG architecture 201 can be the same as the language model 218. Any one or more LMs can be comprised by the RAG securing system 202, external to the RAG securing system 202, comprised by the non-limiting system 200 and/or external to the non-limiting system 200.

In one or more embodiments different language models 218 can be trained and employed for different purposes. For example, different language models 218 can be employed for semantic queries 240A versus retrieved sources 240B. For another example, different language models 218 can be employed based on different types of adversarial attacks. For another example, different language models 218 can be employed for different types of prompt-misleading text. In one or more embodiments, different language models 218 can be employed for a same semantic source 240 (e.g., as described below relative to the iterating component 224). In one or more embodiments, different language models 218 can be employed for text identified as biased text and/or for text identified as prompt-misleading but non-malicious. Furthermore, different language models 218 of a same RAG securing system 202 can be employed for different semantic queries 240A (e.g., for different instances of execution of the RAG securing system 202 relative to different instances of execution of one or more RAG architectures 201).

Any one of these examples can be employed with any one or more other of these examples. Any one of these examples can be employed at least partially in parallel with another one or more of these examples. Further, these examples are not intended to be mutually exclusive to one another.

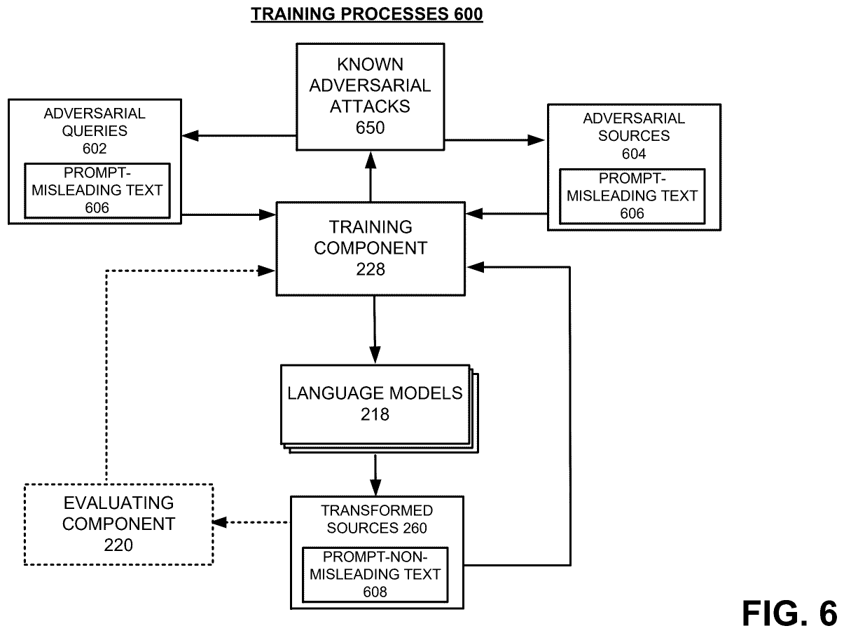

To provide additional detail regarding function of the language model 218 relative to the semantic source 240 provided by the transforming component 214, discussion turns next to FIG. 6 and to the training component 228, which can provide one or more training processes 600 to train one or more language models 218.

For example, the training component 228 can employ one or more known adversarial attacks 650 to purposely cause generation of one or more adversarial queries 602 and/or adversarial sources 604 comprising prompt-misleading text 606 as defined above based on a set of one or more known semantic queries 240A and/or based on a set of one or more known sources 240B.

Using the adversarial outputs (e.g., adversarial queries 602 and/or adversarial sources 604) generated by and/or in view of the known adversarial attacks 650, one or more comparisons can be generated by the training component 228 to corresponding transformed queries 660A and/or to transformed retrieved sources 640B. In one or more embodiments, the one or more training processes 600 can employ user entity feedback to provide one or more comparisons.

Also using the adversarial outputs (e.g., adversarial queries 602 and/or adversarial sources 604) generated by and/or in view of the known adversarial attacks 650, the training component 228 can direct a language model 218 to generate a corresponding transformed source 260. The transformed source 260 can be compared to a specified transformed source. The transformed source 260 can be analyzed based on one or more thresholds defining parameters of change between prompt-misleading text 606 and prompt-non-misleading text 608. That is, put another way, identified adversarial queries and/or their elicited LLM responses can be gathered. Adversarial and corresponding benign queries can help train a robust paraphraser, converting adversarial inputs into benign counterparts.

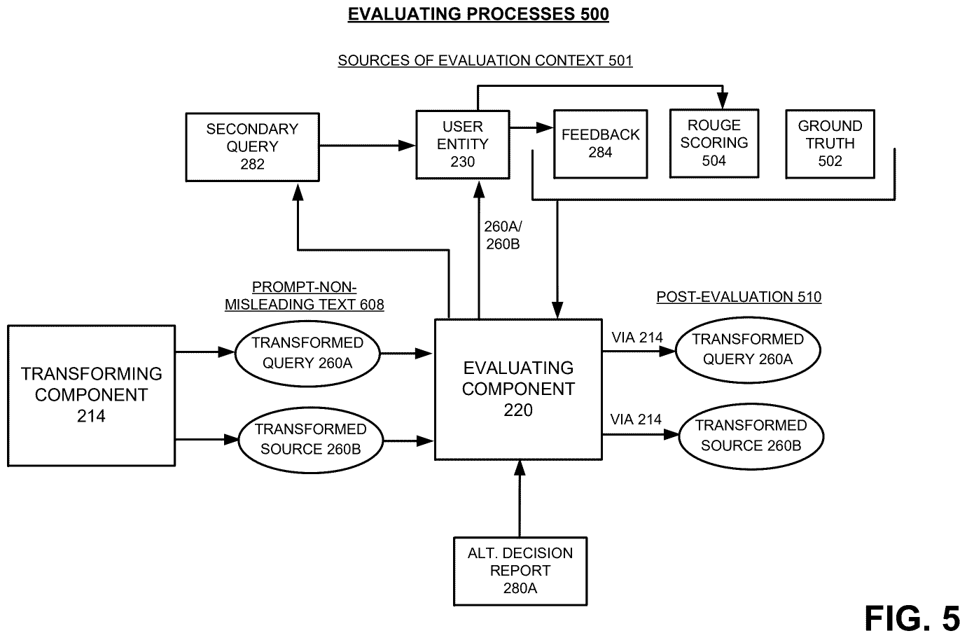

In one or more embodiments, one or more evaluating processes 500 (FIG. 5) can be employed during the training processes 600, with one or more results of the training fed into the training component 228 by the evaluating component 220. These evaluating processes 500 will be discussed below, and can be employed in association with the training processes 600 and/or during use of any one or more instances of execution of the RAG securing system 202.

In response to any one or more of the above processes that can be performed by and/or using the training component 228, including those performed by the evaluating component 220, the training component 228 can adjust, and/or cause to be adjusted, one or more parameters/hyperparameters of the corresponding language model 218, thereby at least partially tuning the language model 218 relative to use by/with the RAG securing system 202.

That is, based on the above, the RAG securing system 202 can improve a process of retrieval augmented generation, of a RAG architecture 201, by the RAG securing system 202 using a combination of adversarial prompting (e.g., by the training component 228) and LLM-based automation (e.g., by the transforming component 214 and language model 218), thereby providing for safe-prompting. As used herein, the term “safe-prompting” can refer to reduction and/or removal of unintended and/or malicious bias and/or other prompt-misleading text.

Discussion next turns to the evaluating component 220 and to the evaluating processes 500 schematically illustrated at FIG. 5, which can be employed to check for inconsistency and/or to address inconsistency of inputs being evaluated. As noted above, one or more evaluating processes 500 can be employed in association with the training processes 600 and/or during use of any one or more instances of execution of the RAG securing system 202. During training processes 600 and/or during RAG securing system 202 normal execution, the one or more evaluating processes 500 can be employed relative to inputs of transformed sources 260 output by the transforming component 214/language model 218. To facilitate the evaluating, in one or more embodiments, responses output from the language model 218 employed by the transforming component 214 can be recorded and/or directed to be recorded by the evaluating component 220, allowing for subsequent evaluation to ensure outputs are coherent and aligned.

That is, the evaluating component 220 can, using an input of a recorded transformed source 260 (e.g., transformed query 260A and/or transformed retrieved source 260B), evaluate the transformed source 260 using one or more sources of evaluation context 501. For example, regarding the aforementioned semantic similarity through paraphrasing, responses can be evaluated for consistency, by the evaluating component 220, using recall-oriented understudy for gisting evaluation (ROUGE) scores and/or ground truth answers, and/or can be submitted to a user entity device for entity feedback to allow for assessment of factual accuracy. It will be appreciated that two or more transformed sources 260 can be evaluated by the evaluating component 220 at least partially in parallel with one another, using one or more same and/or different sources of evaluation context 501.

Again, these sources of evaluation context 501 can comprise, but are not limited to, a secondary query 282 generated by the evaluating component 220, feedback 284, ROUGE scoring 504 and/or ground truth 502.

It is noted that each of the secondary query 282 and/or feedback 284 can employ a user entity 230. Accordingly, to facilitate these sources of evaluation context 501, it is noted that the evaluating component 220 can communicate with and/or provide communications to a computer device associated with the user entity 230.

Turning first to user entity feedback 284, a user entity 230 can provide feedback 284 without being prompted and/or in response to a particular prompt generated and sent by the evaluating component 220. In either case, the user entity 230 can have access to the transformed source 260 to be evaluated, such as by the user entity 230 employing a computer device associated with the user entity 230 and having communicative access to the RAG securing system 202. User entity feedback 284 can employ any method of scoring, such as ROUGE scoring 504 (to be discussed below), and/or such as comparison to a threshold.

For example, a threshold can be merely whether a transformed source 260 is satisfactory. If so, the threshold is satisfied. For another example, a threshold can be percentage based, such as whether a transformed source 260 is at least 80% satisfactory. These thresholds can be subjective in nature.

As noted above, ROUGE scoring 504 can be employed. ROUGE scoring can refer to a suite of scores used for evaluating summarization and machine translation tasks by comparing the machine generated text with a set of reference summaries produced by user entity annotators. This is an approach recognized in intellectual communities as a gold standard. ROUGE scoring can be dependent upon provision of reference summaries (e.g., here, reference transformed sources), which can be provided by a user entity 230, be obtained from historical data, etc.

Different variants of ROUGE scoring 502 can evaluate the machine generated text using different methods. Generally, a ROUGE score calculates a recall of n-grams in a machine generated summary by comparing the machine generated summary to a reference summary. As used herein, a recall of n-grams is a number of n-grams that are comprised by each of the machine generated summary (here the transformed source 260) and the reference summary. For example, ROUGE-1 can identify overlap of unigrams, ROUGE-2 can identify overlap of bigrams, and ROUGE-L can identify a longest common subsequence (LCS). ROUGE-N can measure an overlap of n-grams (e.g., a contiguous sequence of n words). ROUGE-S can measure skip-bigram (e.g., a bigram with no more than one intervening word). These various ROUGE scorings can employ different measurement parameters of precision, recall and/or F1-score based on the overlap. In one or more embodiments, a ROUGE score can range between, and including, 0 and 1, where high values indicate better transformed source quality, while 0 indicates a fully incorrect transformed source.

Also as noted above, one or more secondary queries 282 can be generated by the evaluating component 220 and directed to a user entity 230. For example, the evaluating component 220 can generate a secondary query 282 directed to a portion of a transformed source 260. In another example, the evaluating component 220 can generate a secondary query 282 requesting a user entity 230 to revise a semantic query 240A. In one or more embodiments, any use of a secondary query 282 can be enabled and/or disabled at runtime, such as being disabled to reduce financial and/or time overhead.

Also as noted above, one or more transformed sources 260 can be compared to ground truth 502. Ground truth 502 can be obtained from a database, such as the database 301 or other database communicatively accessible by the RAG securing system 202. Relative to the database 301 and/or any other database accessible by the RAG securing system 202, data can be stored in any format including, but not limited to data, metadata, list, matrix, folder system, vectors, etc. In one or more embodiments, a ground truth threshold can be employed based on a comparison of a transformed source 260 to a ground truth 502. Any of the threshold types discussed above, and/or any other suitable type, can be employed.

For example, ground truth 502 can be employed to determine a variability in outputs of one or more LMs 218 to a same semantic query 240A, which in turn can be detailed a decision report 280 and/or alternative decision report 280A, as described below. That is, such ground truth 502 can be employed to describe a level of uncertainty in the outputs (e.g., transformed sources 260) to the LMs 218 that were employed by the RAG SS 202.

For another example, ground truth 502 can be employed when the RAG SS 202 is converging towards correct and/or incorrect output, such as based on one or more different aggregated outputs compared to one another.

It is noted that the ground truth 502 likewise can be employed to facilitate generation of one or more adversarial queries for use in the training processes 600 (FIG. 6).

Any one or more of the above sources of evaluation context 501 can be employed alone and/or in combination with any one or more other of the above sources of evaluation context 501. Indeed, in one or more embodiments, the sources of evaluation context 501 are not mutually exclusive.

As a result of use of the one or more sources of evaluation 501, and/or on an alternative decision report 280A to be discussed below, in one or more post-evaluation steps 510, the evaluating component 220 can request the transforming component 214 to re-generate the transformed source 260 by taking into account one or more outputs of the sources of evaluation context 501. For example, the evaluating component 220 and/or the transforming component 214 can transform one or more of the outputs into to one or more vectors to be employed by the transforming component 214 based on the previous transformed source 260 that was evaluated.

Based on the above use of the evaluating processes 500 and/or training processes 600, the RAG securing system 202 can be a self-improving system. That is, the RAG securing system 202 can automatically generate one or more outputs as a result of the evaluating processes 500 and/or training processes 600, and automatically employing such one or more outputs to tune one or more parameters of one or more language models 218 of the RAG securing system 202 and/or employed by the RAG securing system 202. For example, given a number of output candidate responses from the evaluating component 220, parameters of each LM 218 in an ensemble and/or parameters of the transforming component 214 can be tuned such that a set of outputs (e.g., transformed sources 260) can converge to returning high ROUGE scoring 504 (e.g., to overlap with ground truth 502), thus minimizing variability (e.g., such as hallucinations) in LM outputs (e.g., transformed sources 260).

In these ways, based on both initial training (e.g., before a first initialization/execution of a first instance by the RAG securing system 202) and evaluating and training based on executed instances of use of the RAG securing system 202, relevancy, precision and/or accuracy of outputs of the RAG securing system 202 can be increased. In one or more cases, one or more types of adversarial attacks and/or one or more types of prompt-misleading text 606, upon which a language model 218 is not trained, can be addressed by the RAG securing system 202. That is, the RAG securing system 202 can be self-improving by self-training its one or more language models 218 on such one or more types of adversarial attacks and/or on one or more types of prompt-misleading text 606.

Discussion next turns to the directing component 222. In one or more embodiments, the directing component can communicate by any suitable means with the RAG architecture 201 to thereby direct use of a transformed source 260 as an input to the RAG architecture 201. As noted above, in one or more embodiments, the directing component 222 can direct the RAG architecture 201 to employ the transformed source 260 in place of a non-transformed semantic source 240. For example, as illustrated at FIG. 4, the directing component 222 can direct a transformed query 260A to be employed in place of and/or as supplement to a semantic query 240A and/or a transformed retrieved source 260B to be employed in place of and/or as supplement to a semantic retrieved source 240B.

That is, one or more transformed retrieved sources 260B along with a transformed query 260A can influence the prompt generator 303 of a RAG architecture 201, upon direction of the directing component 222 (e.g., using the RAG securing system 202).

In one or more embodiments, a plurality of executions of the RAG securing system 202 can be performed, allowing for plural responses 278 to be output relative to a same query 240A (and/or relative to a query 240A and one or more revisions thereof due to one or more secondary queries 282). That is, these plural outputs can provide for consistency of semantic similarity through repeated and/or alternative paraphrasing. For example, the iterating component 224 can direct the transforming component 214 to perform one or more additional iterations of transforming of the same semantic source 240, such as using one or more language models 218 that have not yet been employed for the same semantic source 240.

Using the different outputs of the different instances of executions of the RAG architecture 201 (e.g., the various responses 278 thereof), the reporting component 226 can generate a decision report 280 comparing different outputs of the different instances of executions of the RAG architecture 201 (e.g., the various responses 278 thereof) to one another. In this way, the RAG securing system 202 can provide further plug-and-play input supplementing existing use of a RAG architecture 201, beyond provision of the transformed sources 260.

In one or more embodiments, the decision report 280 can comprise clarification regarding how the responses 278 were generated, including, but not limited to, information about how the semantic source 240 was transformed, text of the original semantic source 240, information about the formatted prompt 310, and/or information defining sources of the LLM 304. In one or more cases, this reporting can comprise the reporting component 226 requesting, receiving and/or obtaining information from the RAG architecture 201.

In one or more embodiments, the reporting component 226 can additionally and/or alternatively generate an alternative decision report 280A comparing different transformed sources 260 output by the transforming component 214 to one another, such as output from different language models 218. In one or more embodiments, this alternative decision report 280A can be employed by the evaluating component 220, such as sent to a user entity 230 to elicit feedback 284 and/or employed by the evaluating component 220 to generate one or more secondary queries 282. In one or more embodiments, the alternative decision report 280A can comprise clarification regarding how the responses 278 were generated, including, but not limited to, information about how the semantic source 240 was transformed. Also in this other way, the RAG securing system 202 can provide further plug-and-play input supplementing existing use of a RAG architecture 201, beyond provision of the transformed sources 260.

As a result of the various components discussed above, and regarding the aforementioned plug-and-play interaction, the one or more processes described above can be seamlessly introduced by the RAG securing system 202 relative to a corresponding RAG architecture 201, allowing for seamless introduction of a robustness layer without overhauling existing RAG architectures. That is, the one or more frameworks described herein can function in a model-agnostic fashion, ensuring easy integration with existing RAG architectures, thereby promoting rapid deployment and adaptability along with efficient scalability relative to plural corresponding RAG architectures (e.g., plural RAG architectures 201) at least partially in parallel with one another. That is, functioning of the RAG architecture 201 can be altered, and RAG architecture 201 output (e.g., responses 278) can be altered, based on use of the RAG securing system 202 in connection with the RAG architecture 201.

In one or more embodiments, use of the RAG securing system 202 can be scalable. For example, two or more semantic sources 240 corresponding to a same semantic query 240A can be transformed at least partially in parallel with one another by the RAG securing system 202. For another example, a same semantic source 240 can be transformed using different language models 218, with the uses of two or more of the language models 218 being at least partially in parallel with one another. For yet another example, two or more semantic sources 240 corresponding to different semantic queries 240A can be transformed at least partially in parallel with one another by the RAG securing system 202. It is noted that these examples can be applicable at a same time, e.g., at least partially in parallel with one another, and thus are not mutually exclusive.

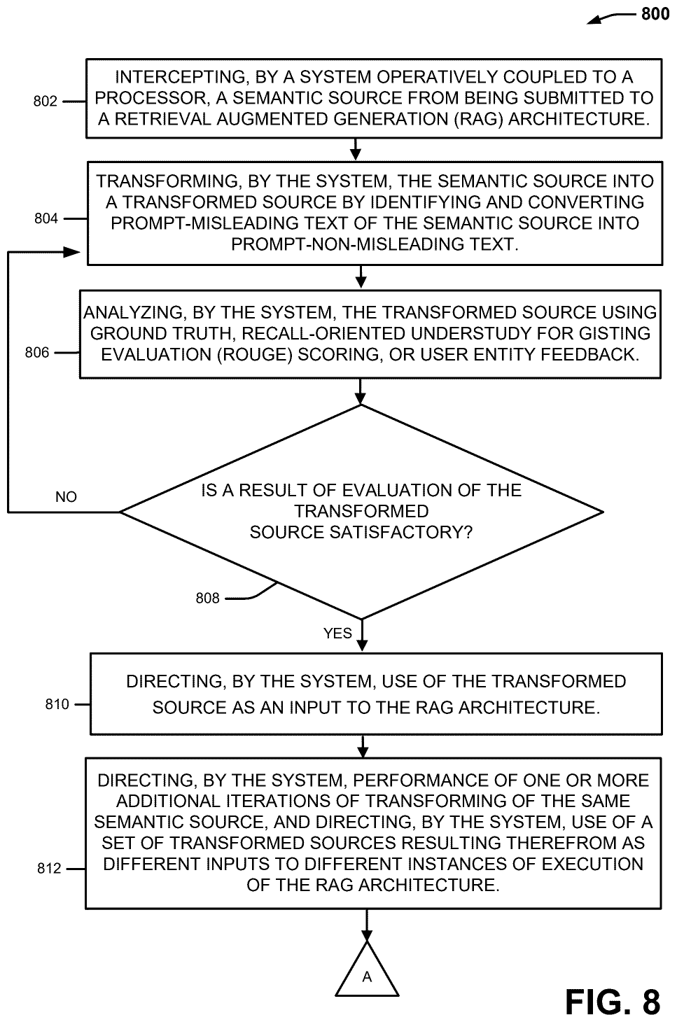

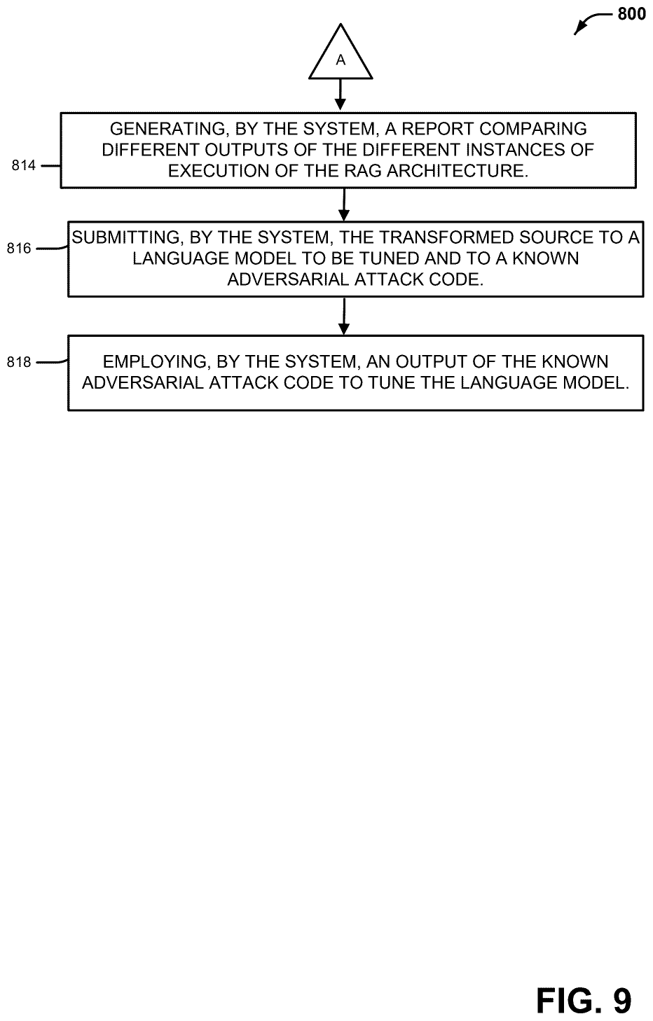

As a summary, referring next to FIGS. 8 and 9, illustrated is a flow diagram of an example, non-limiting method 800 that can provide a process to secure an input to a retrieval augmented generation (RAG) architecture, in accordance with one or more embodiments described herein, such as the non-limiting system 200 of FIG. 2. While the non-limiting method 900 is described relative to the non-limiting system 200 of FIG. 2, the non-limiting method 900 can be applicable also to other systems described herein, such as the non-limiting system 100 of FIG. 1. Repetitive description of like elements and/or processes employed in respective embodiments is omitted for sake of brevity.

At 802, the non-limiting method 800 can comprise intercepting, by a system (e.g., obtaining component 212) operatively coupled to a processor (e.g., processor 206), a semantic source (e.g., semantic source 240) from being submitted to a retrieval augmented generation (RAG) architecture (e.g., RAG architecture 201).

At 804, the non-limiting method 800 can comprise transforming, by the system (e.g., transforming component 214, the semantic source into a transformed source (e.g., transformed source 260) by identifying and converting prompt-misleading text (e.g., prompt-misleading text 606) of the semantic source into prompt-non-misleading text (e.g., prompt-non-misleading text 608).

At 806, the non-limiting method 800 can comprise analyzing, by the system (e.g., evaluating component 220), the transformed source using ground truth, recall-oriented understudy for gisting evaluation (ROUGE) scoring, or user entity feedback.

At 808, the non-limiting method 800 can comprise determining, by the system (e.g., evaluating component 220), whether a result of step 806 (e.g., evaluation of the transformed source) is satisfactory. If yes, the non-limiting method 800 can proceed to step 810. If not, the non-limiting method 800 can proceed back to step 804 for additional transforming based on an output of the evaluating step 806.

At 810, the non-limiting method 800 can comprise directing, by the system (e.g., directing component 222), use of the transformed source as an input to the RAG architecture.

At 812, the non-limiting method 800 can comprise directing, by the system (e.g., iterating component 224), performance one or more additional iterations of transforming of the same semantic source, and directing, by the system (e.g., directing component 222) use of a set of transformed sources resulting therefrom as different inputs to different instances of execution of the RAG architecture.

At 814, the non-limiting method 800 can comprise generating, by the system (e.g., reporting component 226), a report comparing different outputs of the different instances of executions of the RAG architecture.

At 816, the non-limiting method 800 can comprise submitting, by the system (e.g., training component 228), the semantic source to a language model (e.g., language model 218) to be tuned and to a known adversarial attack code (e.g., known adversarial attack 650).

At 818, the non-limiting method 800 can comprise tuning, by the system (e.g., training component 228), the language model using an output of the adversarial attack code.

### Additional Summary

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. In addition, the computer-implemented and non-computer-implemented methodologies could alternatively be represented as a series of interrelated states via a state diagram or events. Additionally, the computer-implemented methodologies described hereinafter and throughout this specification are capable of being stored on an article of manufacture for transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

In summary, an exemplary system comprises a memory 104, 204 that stores and a processor 106, 206 that executes computer executable components stored in the memory 104, 204, wherein the computer executable components comprise an obtaining component 112, 212 that intercepts a semantic source 140, 240 from being submitted to a retrieval augmented generation (RAG) architecture 101, 201, and a transforming component 114, 214 that transforms the semantic source 140, 240 into a transformed source 160, 260 by identifying and converting prompt-misleading text 606 of the semantic source into prompt-non-misleading text 608. In one or more embodiments, the semantic source 140, 240 is a semantic query 140A, 240A having been submitted to the RAG architecture 101, 201 and/or a retrieved source 140B, 240B having been retrieved by the RAG architecture 101, 201 in a process of providing a prompt 310. In one or more embodiments, the prompt-misleading text 608 originated in connection with an origination of the semantic source 140, 240 and/or was caused by an adversarial attack 150, 250 corresponding to the semantic source 140, 240.

A benefit of the system, computer-implemented method and/or computer program product, can be an ability to automatically mitigate effect of adversarial attacks to inputs of a RAG architecture, thereby resulting in non-biased and/or factual prompts.

Another benefit can be an ability to provide the aforementioned mitigation with one or more processes being agnostic to RAG architecture type and/or to language model (LM) type.

Indeed, in view of the one or more embodiments described herein, a practical application of the one or more systems, computer-implemented methods and/or computer program products described herein can be an increase in unbiased results output from a corresponding RAG architecture. Furthermore, the use of the one or more embodiments herein can be applicable to parallel use with a plurality of RAG architectures, such that the one or more embodiments described herein can filter (e.g., intercept and transform) semantic sources relative to a plurality of RAG architectures. This can be accomplished by tracking use of the plurality of RAG architectures and/or of one or more databases or other groups of retrievable sources employed by the plurality of RAG architectures.

In connection therewith, the one or more embodiments described herein can therefore provide useful and practical applications of computers, thus providing enhanced (e.g., improved and/or optimized) RAG input and/or RAG output as compared to existing frameworks managing operation of one or more RAGs. Overall, such computerized tools can constitute a concrete and tangible technical improvement in the fields of retrieval augmented generation.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can be, in one or more embodiments, inherently and/or inextricably tied to computer technology and cannot be implemented outside of a computing environment. For example, one or more processes performed by one or more embodiments described herein can more efficiently, and even more feasibly, provide program and/or program instruction execution, such as relative to intercepting and transforming prompt-misleading text, as compared to existing systems and/or techniques unable to provide such efficiencies. Systems, computer-implemented methods and/or computer program products providing performance of these processes are of great utility in the fields retrieval augmented generation and cannot be equally practicably implemented in a sensible way outside of a computing environment.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively automatically or even partially automatically recognize, intercept, access and transform digital data as the one or more embodiments described herein can provide these processes. Moreover, neither can the human mind nor a human with pen and paper conduct these processes, as conducted by one or more embodiments described herein.

In one or more embodiments, one or more of the processes described herein can be performed by one or more specialized computers (e.g., a specialized processing unit, a specialized classical computer, a specialized quantum computer, a specialized hybrid classical/quantum system and/or another type of specialized computer) to execute defined tasks related to the one or more technologies describe above. One or more embodiments described herein and/or components thereof can be employed to solve new problems that arise through advancements in technologies mentioned above, employment of quantum computing systems, cloud computing systems, computer architecture and/or another technology.

One or more embodiments described herein can be fully operational towards performing one or more other functions (e.g., fully powered on, fully executed and/or another function) while also performing one or more of the one or more operations described herein.

To provide additional summary, a listing of embodiments and features thereof is provided.

A system, comprising: a memory that stores computer executable components; and a processor, operably coupled to the memory, that executes the computer executable components stored in the memory, wherein the computer executable components comprise: an obtaining component that intercepts a semantic source from being submitted to a retrieval augmented generation (RAG) architecture; and a transforming component that transforms the semantic source into a transformed source by identifying and converting prompt-misleading text of the semantic source into prompt-non-misleading text.

The system of the preceding paragraph, wherein the semantic source is a semantic query having been submitted to the RAG architecture.

The system of any preceding paragraph, wherein the semantic source is a retrieved source having been retrieved by the RAG architecture in a process of providing a prompt.

The system of any preceding paragraph, wherein the prompt-misleading text originated in connection with an origination of the semantic source.

The system of any preceding paragraph, wherein the prompt-misleading text was caused by an adversarial attack corresponding to the semantic source.

The system of any preceding paragraph, further comprising: an evaluating component that analyzes the transformed source using ground truth, recall-oriented understudy for gisting evaluation (ROUGE) scoring, or user entity feedback.

The system of any preceding paragraph, further comprising: a training component that submits the transformed source to a language model to be tuned and to a known adversarial attack code.

The system of any preceding paragraph, further comprising: a directing component that directs use of the transformed source as an input to the RAG architecture.

The system of any preceding paragraph, further comprising: an iterating component that directs the transforming component to perform one or more additional iterations of transforming of the same semantic source, and that directs use of a set of transformed sources resulting therefrom as different inputs to different instances of execution of the RAG architecture.

The system of any preceding paragraph, further comprising: a reporting component that generates a report comparing different outputs of the different instances of executions of the RAG architecture.

A computer-implemented method, comprising: intercepting, by a system operatively coupled to a processor, a semantic source from being submitted to a retrieval augmented generation (RAG) architecture; and transforming, by the system, the semantic source into a transformed source by identifying and converting prompt-misleading text of the semantic source into prompt-non-misleading text.

The computer-implemented method of the preceding paragraph, wherein the semantic source is a semantic query having been submitted to the RAG architecture or a retrieved source having been retrieved by the RAG architecture in a process of providing a prompt.

The computer-implemented method of any preceding paragraph, wherein the prompt-misleading text originated in connection with an origination of the semantic source or was caused by an adversarial attack corresponding to the semantic source.

The computer-implemented method of any preceding paragraph, further comprising: submitting, by the system, the semantic source to a language model to be tuned and to a known adversarial attack code; and employing, by the system, an output of the adversarial attack to tune the language model.

The computer-implemented method of any preceding paragraph, further comprising: directing, by the system, performance of one or more additional iterations of transforming of the same semantic source, and that directs use of a set of transformed sources resulting therefrom as different inputs to different instances of execution of the RAG architecture; and generating, by the system, a report comparing different outputs of the different instances of execution of the RAG architecture.

A computer program product facilitating a process to secure input to retrieval augmented generation (RAG) architectures, the computer program product comprising a computer readable storage medium having program instructions embodied therewith, the program instructions executable by a processor to cause the processor to: intercept, by the processor, a semantic source from being submitted to a retrieval augmented generation (RAG) architecture; and transform, by the processor, the semantic source into a transformed source by identifying and converting prompt-misleading text of the semantic source into prompt-non-misleading text.

The computer program product of the preceding paragraph, wherein the semantic source is a semantic query having been submitted to the RAG architecture or a retrieved source having been retrieved by the RAG architecture in a process of providing a prompt.

The computer program product of any preceding paragraph, wherein the prompt-misleading text originated in connection with an origination of the semantic source or was caused by an adversarial attack corresponding to the semantic source.

The computer program product of any preceding paragraph, further comprising: submit, by the processor, the semantic source to a language model to be tuned and to a known adversarial attack code; and employ, by the processor, an output of the adversarial attack to tune the language model.

The computer program product of any preceding paragraph, wherein the program instructions are further executable by the processor to cause the processor to: direct, by the processor, performance of one or more additional iterations of transforming of the same semantic source, and that directs use of a set of transformed sources resulting therefrom as different inputs to different instances of execution of the RAG architecture; and generate, by the processor, a report comparing different outputs of the different instances of execution of the RAG architecture.

### Computing Environment Description

Turning next to FIG. 10, a detailed description is provided of additional context for the one or more embodiments described herein at FIGS. 1-9.

FIG. 10 and the following discussion are intended to provide a brief, general description of a suitable computing environment 1000 in which one or more embodiments described herein at FIGS. 1-9 can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1000 contains an example of an environment for the execution of at least some of the computer code involved in performing the inventive methods, such as translation of an original source code based on a configuration of a target system by the RAG securing code 1080. In addition to block 1080, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1080, as identified above), peripheral device set 1014 (including user interface (UI), device sct 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, one or more instructions for performing the inventive methods may be stored in block 1080 in persistent storage 1013.

COMMUNICATION FABRIC 1011 is the signal conduction path that allows the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid-state storage devices. Operating system 1022 may take several forms, such as various known proprietary operating systems or open-source Portable Operating System Interface type operating systems that employ a kernel. The code included in block 1080 typically includes at least some of the computer code involved in performing the inventive methods.

PERIPHERAL DEVICE SET 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001) and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

REMOTE SERVER 1004 is any computer system that serves at least some data and/or functionality to computer 1001. Remote server 1004 may be controlled and used by the same entity that operates computer 1001. Remote server 1004 represents the machine that collects and stores helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate via WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud. ADDITIONAL CLOSING INFORMATION

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer executable components; and
a processor, operably coupled to the memory, that executes the computer executable components stored in the memory, wherein the computer executable components comprise:
an obtaining component that intercepts a semantic source from being submitted to a retrieval augmented generation (RAG) architecture; and
a transforming component that transforms the semantic source into a transformed source by identifying and converting prompt-misleading text of the semantic source into prompt-non-misleading text.

2. The system of claim 1, wherein the semantic source is a semantic query having been submitted to the RAG architecture.

3. The system of claim 1, wherein the semantic source is a retrieved source having been retrieved by the RAG architecture in a process of providing a prompt.

4. The system of claim 1, wherein the prompt-misleading text originated in connection with an origination of the semantic source.

5. The system of claim 1, wherein the prompt-misleading text was caused by an adversarial attack corresponding to the semantic source.

6. The system of claim 1, further comprising:
an evaluating component that analyzes the transformed source using ground truth, recall-oriented understudy for gisting evaluation (ROUGE) scoring, or user entity feedback.

7. The system of claim 1, further comprising:
a training component that submits the transformed source to a language model to be tuned and to a known adversarial attack code and tunes the language model based on an output of the adversarial attack code.

8. The system of claim 1, further comprising:
a directing component that directs use of the transformed source as an input to the RAG architecture.

9. The system of claim 1, further comprising:
an iterating component that directs the transforming component to perform one or more additional iterations of transforming of the same semantic source; and
a directing component that directs use of a set of transformed sources resulting therefrom as different inputs to different instances of execution of the RAG architecture.

10. The system of claim 9, further comprising:
a reporting component that generates a report comparing different outputs of the different instances of executions of the RAG architecture.

11. A computer-implemented method, comprising:
intercepting, by a system operatively coupled to a processor, a semantic source from being submitted to a retrieval augmented generation (RAG) architecture; and
transforming, by the system, the semantic source into a transformed source by identifying and converting prompt-misleading text of the semantic source into prompt-non-misleading text.

12. The computer-implemented method of claim 11, wherein the semantic source is a semantic query having been submitted to the RAG architecture or a retrieved source having been retrieved by the RAG architecture in a process of providing a prompt.

13. The computer-implemented method of claim 11, wherein the prompt-misleading text originated in connection with an origination of the semantic source or was caused by an adversarial attack corresponding to the semantic source.

14. The computer-implemented method of claim 11, further comprising:
submitting, by the system, the semantic source to a language model to be tuned and to a known adversarial attack code; and
tuning, by the system, the language model using an output of the adversarial attack code.

15. The computer-implemented method of claim 11, further comprising:
directing, by the system, performance of one or more additional iterations of transforming of the same semantic source;
directing, by the system, use of a set of transformed sources resulting therefrom as different inputs to different instances of execution of the RAG architecture; and
generating, by the system, a report comparing different outputs of the different instances of execution of the RAG architecture.

16. A computer program product facilitating a process to secure input to retrieval augmented generation (RAG) architectures, the computer program product comprising a computer readable storage medium having program instructions embodied therewith, the program instructions executable by a processor to cause the processor to:
intercept, by the processor, a semantic source from being submitted to a retrieval augmented generation (RAG) architecture; and
transform, by the processor, the semantic source into a transformed source by identifying and converting prompt-misleading text of the semantic source into prompt-non-misleading text.

17. The computer program product of claim 16, wherein the semantic source is a semantic query having been submitted to the RAG architecture or a retrieved source having been retrieved by the RAG architecture in a process of providing a prompt.

18. The computer program product of claim 16, wherein the prompt-misleading text originated in connection with an origination of the semantic source or was caused by an adversarial attack corresponding to the semantic source.

19. The computer program product of claim 16, further comprising:
submit, by the processor, the semantic source to a language model to be tuned and to a known adversarial attack code; and
tune, by the processor, the language model using an output of the adversarial attack code.

20. The computer program product of claim 16, wherein the program instructions are further executable by the processor to cause the processor to:
direct, by the processor, performance of one or more additional iterations of transforming of the same semantic source;
direct, by the processor, use of a set of transformed sources resulting therefrom as different inputs to different instances of execution of the RAG architecture; and
generate, by the processor, a report comparing different outputs of the different instances of execution of the RAG architecture.
